(19) United States
(12) Patent Application Publication
(10) Pub. No.: US 2019/0035015 A1
(43) Pub. Date: Jan. 31, 2019

(54) METHOD AND APPARATUS FOR OBTAINING A STABLE CREDIT SCORE

(71) Applicant: Alibaba Group Holding Limited, George Town, Grand Cayman (KY)

(72) Inventor: Qiangpeng YANG, Hangzhou (CN)

(21) Appl. No.: 16/080,525

(22) PCT Filed: Feb. 16, 2017
(86) PCT No.: PCT/CN2017/073756

§ 371 Date: Aug. 28, 2018

(30) Foreign Application Priority Data
Feb. 29, 2016 (CN) 201610113530.6

(51) Int. Cl. G06Q 40/02; G06F 17/11; G06N 3/04

(52) U.S. Cl. CPC G06Q 40/025; G06N 3/0481; G06F 17/11

(57) ABSTRACT

Method and apparatus for obtaining a stable credit score for improved credit management. In an embodiment, the method comprises: configuring an obtaining module in a computer system to obtain input data from a user and providing the input data to a deep neural network; configuring a processing module to process the input data through the deep neural network to obtain a credit probability value; configuring an obtaining module to obtain a credit score of the user by using the credit probability value outputted by the deep neural network; and selecting a scaling hyperbolic tangent in the deep neural network as an activation function; calculating, by using the scaling hyperbolic tangent, a first eigenvector value outputted by an upper level to obtain a second eigenvector value; and outputting the second eigenvector value to a next level, to obtain the stable credit score. In embodiments, the present invention enhances the stability of the credit score and avoid great changes in the credit score, thereby improving users' experience.

### PRIORITY CLAIM

The present application claims priority to Chinese Patent Application No. 201610113530.6, entitled “METHOD AND APPARATUS FOR OBTAINING CREDIT SCORE AND OUTPUTTING FEATURE VECTOR VALUE”, filed on Feb. 29, 2016, and corresponding to PCT Patent Application No. PCT/CN2017/073756 filed Feb. 16, 2017, and PCT Publication No. WO/2017/148269, all of which are incorporated herein by reference in their entirety.

### TECHNICAL FIELD

The present application relates to the field of Internet technology, and in particular, to a method and an apparatus for obtaining a stable credit score or a stable social credit score and outputting an eigenvector value, for use in credit management.

### BACKGROUND

Sesame Credit is an independent third-party credit assessment and credit management agency. Based on all aspects of information, it uses big data and cloud computing technology to objectively present an individual's credit status. By connecting the credit with various services, Sesame Credit enables everyone to experience the benefits and advantages of their credit. A Sesame Credit analyzes a large number of online transactions and behavioral data and conducts credit assessment on users. These credit assessments can help Internet finance companies to conclude users' willingness and abilities in making payments, and then users will be provided with fast credit granting and cash installment services. For example, Sesame Credit data covers services such as credit card repayment, online shopping, transfer, wealth management, water, electricity and gas payment, rental information, address relocation history, social relations and other services.

A Sesame credit score is an assessment result after Sesame Credit analyzes massive information data; and the Sesame credit score may be determined based on five dimensions: a user's credit history, behavioral habits, ability to pay off debts, personal traits, and social networks.

### SUMMARY

The present invention provides a method and an apparatus for obtaining a stable credit score or a stable social credit score and outputting an eigenvector value, so as to enhance the stability of the credit score or a stable social credit score, avoiding great changes in the credit score or a social credit score thereby improving users' experience. Technical solutions are as follows:

The present invention provides a method for obtaining a stable credit score or a stable social credit score, and the method comprises the following steps:

configuring an obtaining module to obtain input data from a user and providing the input data to a deep neural network;

configuring a processing module to process the input data through the deep neural network to obtain a credit probability value;

configuring an obtaining module to obtain a credit score of the user by using the credit probability value outputted by the deep neural network; and

selecting a scaling hyperbolic tangent in the deep neural network as an activation function; calculating, by using the scaling hyperbolic tangent, a first eigenvector value outputted by an upper level to obtain a second eigenvector value; and outputting the second eigenvector value to a next level, to obtain the stable credit score.

The process of selecting a scaling hyperbolic tangent as an activation function comprises: determining a hyperbolic tangent and reducing a slope of the hyperbolic tangent, so as to obtain the scaling hyperbolic tangent; and selecting the scaling hyperbolic tangent as the activation function for the deep neural network.

The scaling hyperbolic tangent comprises: scaled tan h(x)=β*tan h(α*x);

when the scaling hyperbolic tangent is used to calculate the first eigenvector value outputted by the upper level so as to obtain the second eigenvector value, x is the first eigenvector value, scaled tan h(x) is the second eigenvector value, tan h(x) is the hyperbolic tangent, β and α are preset values, and α is less than 1 and greater than 0.

The first eigenvector value outputted by the upper level comprises:

an eigenvector value of a data dimension outputted by a hidden layer of the deep neural network; and eigenvector values of a plurality of data dimensions outputted by a module layer of the deep neural network.

The present invention provides a method for outputting an eigenvector value, applied to a deep neural network, wherein the method comprises the following steps:

selecting a scaling hyperbolic tangent as an activation function for the deep neural network;

calculating, by using the scaling hyperbolic tangent, a first eigenvector value outputted by an upper level of the deep neural network to obtain a second eigenvector value; and

outputting the second eigenvector value to a next level of the deep neural network.

The selecting a scaling hyperbolic tangent as an activation function for the deep neural network comprises: determining a hyperbolic tangent and reducing the slope of the hyperbolic tangent, so as to obtain the scaling hyperbolic tangent; and selecting the scaling hyperbolic tangent as the activation function for the deep neural network.

The scaling hyperbolic tangent comprises: scaled tan h(x)=β*tan h(α*x);

when the scaling hyperbolic tangent is used to calculate the first eigenvector value outputted by the upper level so as to obtain the second eigenvector value, x is the first eigenvector value, scaled tan h(x) is the second eigenvector value, tan h(x) is the hyperbolic tangent, β and α are preset values, and α is less than 1 and greater than 0.

The present invention provides an apparatus for obtaining a stable credit score or a stable social credit score, wherein the apparatus comprises:

an obtaining module, configured to obtain input data from a user;

a providing module, configured to provide the input data to a deep neural network;

a processing module, configured to process the input data with the deep neural network to obtain the credit probability value, wherein a scaling hyperbolic tangent in the deep neural network is selected as an activation function; calculate, by using the scaling hyperbolic tangent, a first eigenvector value outputted by an upper level to obtain a second eigenvector value; and output the second eigenvector value to a next level; and

an acquisition module, configured to acquire a stable credit score or a stable social credit score of the user by using the credit probability value outputted by the deep neural network.
The processing module is configured to determine, in the process of selecting the scaling hyperbolic tangent as the activation function, a hyperbolic tangent and reduce the slope of the hyperbolic tangent, so as to obtain the scaling hyperbolic tangent; and select the scaling hyperbolic tangent as the activation function for the deep neural network.

The scaling hyperbolic tangent selected by the processing module comprises: scaled tan h(x)=β*tan h(α*x); in the process of the processing module using the scaling hyperbolic tangent to calculate the first eigenvector value outputted by the upper level so as to obtain the second eigenvector value, x is the first eigenvector value, scaled tan h(x) is the second eigenvector value, tan h(x) is the hyperbolic tangent, β and α are preset values, and α is less than 1 and greater than 0.

The first eigenvector value outputted by the upper level comprises:

an eigenvector value of a data dimension outputted by a hidden layer of the deep neural network; and eigenvector values of a plurality of data dimensions outputted by a module layer of the deep neural network.

The present invention provides an apparatus for outputting an eigenvector value, wherein the apparatus for outputting a eigenvector value is applied to a deep neural network, and the apparatus for outputting a eigenvector value comprises:

a selection module, configured to select a scaling hyperbolic tangent as an activation function of the deep neural network;

an obtaining module, configured to calculate, by using the scaling hyperbolic tangent, a first eigenvector value outputted by an upper level of the deep neural network to obtain a second eigenvector value; and

an output module, configured to output the second eigenvector value to a next level of the deep neural network.

The selection module is configured to determine, in the process of selecting the scaling hyperbolic tangent as the activation function for the deep neural network, a hyperbolic tangent and reduce the slope of the hyperbolic tangent, so as to obtain the scaling hyperbolic tangent; and select the scaling hyperbolic tangent as the activation function for the deep neural network.

The scaling hyperbolic tangent selected by the selection module comprises: scaled tan h(x)=β*tan h(α*x); in the process of the obtaining module using the scaling hyperbolic tangent to calculate the first eigenvector value outputted by the upper level so as to obtain the second eigenvector value, x is the first eigenvector value, scaled tan h(x) is the second eigenvector value, tan h(x) is the hyperbolic tangent, β and α are preset values, and α is less than 1 and greater than 0.

Based on the above technical solutions, in embodiments of the present invention, the scaling hyperbolic tangent is used as the activation function to enhance the stability of the deep neural network. When the deep neural network is applied to a personal credit reference system, it can enhance the stability of the credit score or the social credit score, avoiding great changes in the credit score or the social credit score, and thereby improving use experience. For example, when there is a great change in the user's data over time, such as consumer data may have greater changes on different dates (such as a sudden change on a certain day), it can be ensured that the user's credit is in a stable state; that is, the credit score or a social credit score only has a small change, and the stability of the credit score or a social credit score is ensured.

### BRIEF DESCRIPTION OF THE DRAWINGS

In order to illustrate the technical solutions in the embodiments of the present invention or in the prior art more clearly, the drawings required for describing the embodiments will be introduced briefly below. Evidently, the drawings described below are merely some embodiments of the present invention: and a person of ordinary skill in the art can also obtain other drawings based on these drawings.

FIG. 1 is a schematic structural diagram of a deep neural network according to an embodiment of the present invention;

FIG. 2 is a schematic graphical diagram of an activation function according to an embodiment of the present invention;

FIG. 3 is a flowchart of a method for outputting an eigenvector value according to an embodiment of the present invention;

FIG. 4 is a schematic graphical diagram of an activation function according to an embodiment of the present invention;

FIG. 5 is a flowchart of a method for obtaining a credit score or a social credit score according to an embodiment of the present invention;

FIG. 6 is a structural diagram of a device on which an apparatus for obtaining a credit score or a social credit score is provided according to an embodiment of the present invention;

FIG. 7 is a structural diagram of an apparatus for obtaining a credit score or a social credit score according to an embodiment of the present invention;

FIG. 8 is a structural diagram of a device on which an apparatus for outputting an eigenvector value is provided according to an embodiment of the present invention; and

FIG. 9 is a structural diagram of an apparatus for outputting an eigenvector value according to an embodiment of the present invention.

### DETAILED DESCRIPTION

The terms used in the present application are for the purpose of describing particular embodiments only and are not intended to limit the present invention. The singular forms “a”, “an”, and “the” used in the present application and the claims are also intended to include plural forms, unless the context clearly indicates otherwise. It should also be understood that the term “and/or” as used herein refers to and encompasses any or all possible combinations of one or more of the associated listed items.

It should be understood that although various types of information may be described using terms such as first, second, and third in the present application, such information should not be limited by these terms. These terms are only used to distinguish the same type of information from one another. For example, first information may also be referred to as second information, and similarly, second information may also be referred to as first information without departing from the scope of the present invention. In addition, depending on the context, the word “if” as used herein may be construed to mean “when . . . ” or “upon . . . ” or “in response to determining”.

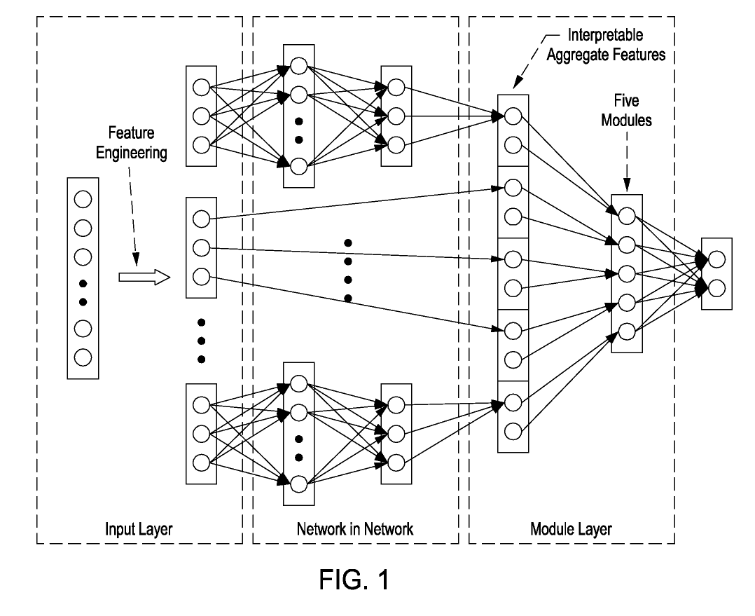

In order to determine a credit score or a social credit score (such as Sesame credit score) based on data from five dimensions: users' credit history, behavioral habits, ability to pay off debts, personal traits, and social networks, in one example, a DNN (Deep Neural Networks) structure shown in FIG. 1 may be used to determine the credit score or a social credit score. The structure of the deep neural network may include an input layer, a hidden layer (network in network), a module layer, and an output layer.

In the input layer of the deep neural network, the input data is data of the five dimensions, i.e., users' credit history, behavioral habits, ability to pay off debts, personal traits, and social networks. These data form a feature set that includes mass values like a feature set (100, 6, 30000, −200, 60, 230, 28). For the feature set, it needs to be processed by feature engineering; for example, a normalization process is performed on the feature set to obtain an eigenvector value. For example, an eigenvector value (0.2, 0.3, 0.4, 0.8, 0.9, −0.1, −0.5, 0.9, 0.8, 0.96) is obtained through a normalization process.

The reason for normalization is described as follows: because the data ranges are different in the feature set, the range of some data may be particularly large, which results in slow convergence and long training time. Moreover, data with a large data range may play an excessive role in mode classification, whereas data with a small data range may play a smaller role; the data can therefore be normalized to be mapped to an interval of [0,1], an interval of [−1,1], or a smaller interval to avoid problems caused because of the data ranges.

After the eigenvector value (0.2, 0.3, 0.4, 0.8, 0.9, −0.1, −0.5, 0.9, 0.8, 0.96) is obtained, assuming that the eigenvector value includes an eigenvector value (0.2, 0.3) that corresponds to user credit history, an eigenvector value (0.4, 0.8) that corresponds to behavioral habits, an eigenvector value (0.9, −0.1) that corresponds to the ability to pay off debts, an eigenvector value (−0.5, 0.9) that corresponds to personal traits, an eigenvector value (0.8, 0.96) that corresponds to social networks, the eigenvector value (0.2, 0.3, 0.4, 0.8, 0.9, −0.1, −0.5, 0.9, 0.8, 0.96) is decomposed into eigenvector values of the five dimensions; and the eigenvector values of the five dimensions are sent to the hidden layer or the module layer.

According to actual needs, an eigenvector value of a certain dimension may be configured to enter the hidden layer; and an eigenvector value of a certain dimension may be configured to directly enter the module layer without entering the hidden layer. For example, eigenvector values for the dimensions of users' credit history, behavioral habits, ability to pay off debts, personal traits are configured to enter the hidden layer, and the eigenvector value for the dimension of social networks is configured to enter the module layer. As such, the eigenvector value (0.2, 0.3) that corresponds to users' credit history, the eigenvector value (0.4, 0.8) that corresponds to behavioral habits, the eigenvector value (0.9, −0.1) that corresponds to ability to pay off debts, and the eigenvector value (−0.5, 0.9) that corresponds to personal traits are sent to the hidden layer for processing, and the eigenvector value (0.8, 0.96) that corresponds to social networks is sent to the module layer for processing.

In the hidden layer of the deep neural network, one or more hidden layers are configured for the eigenvector value of each dimension. FIG. 1 illustrates an example of configuring two hidden layers for the eigenvector value of each dimension. Because processing of each dimension in the hidden layer is the same, the following uses the processing of one dimension in the hidden layer as an example. A weight vector W1 and an offset value b1 are configured for the first hidden layer; and a weight vector W2 and an offset value b2 are configured for the second hidden layer. Details of how the weight vector and the offset value are configured are not provided herein.

After the eigenvector value outputted by the input layer is obtained, assuming that an eigenvector value (0.4, 0.8) corresponding to behavioral habits is obtained, then the first hidden layer processes the eigenvector value (0.4, 0.8). In one example, a processing formula may be the eigenvector value (0.4, 0.8)*weight vector W1+offset value b1.

Then, the activation function (such as a nonlinear function) is often used to calculate the eigenvector value (that is, the result of the eigenvector value (0.4, 0.8)*weight vector W1+offset value b1) outputted by the hidden layer, so as to obtain a new eigenvector value (assuming to be an eigenvector value 1); and the new eigenvector value is outputted to the second hidden layer. The activation function may include a sigmoid (S type) function, a ReLU (Rectified Linear Units) function, a tan h (hyperbolic tangent) function and the like. Taking the ReLU function as an example. The ReLU function may set all the features outputted by the hidden layer to 0 if the features are less than 0 and maintain the features that are greater than 0.

Functions of the activation function may include: adding a nonlinear factor;

reducing the noise of the actual data, suppressing data with a large edge singularity; and
constraining the output value of the previous layer.

After obtaining the eigenvector value 1, the second hidden layer processes the eigenvector value 1. In one example, a processing formula may be the eigenvector value 1*weight vector W2+offset value b2. Then, the activation function is used to calculate the eigenvector value outputted by the hidden layer, so as to obtain a new eigenvector value (assuming to be an eigenvector value 2); and the new eigenvector value is outputted to the module layer.

In the module layer of the deep neural network, the eigenvector values (see interpretable aggregate features in FIG. 1, i.e., combinable features) for the five dimensions are combined together to obtain a new eigenvector value (the new eigenvector value includes five dimensions, i.e., “five modules”). The eigenvector value may include the eigenvector value outputted by the hidden layer to the module layer and the eigenvector value directly outputted by the input layer to the module layer. For example, the eigenvector value includes an eigenvector value corresponding to users' credit history outputted by the hidden layer to the module layer; an eigenvector value corresponding to behavioral habits outputted by the hidden layer to the module layer; an eigenvector value corresponding to ability to pay off debts outputted by the hidden layer to the module layer; an eigenvector value corresponding to personal traits outputted by the hidden layer to the module layer; and an eigenvector value corresponding to social networks directly outputted by the input layer to the module layer. Further, the activation function is used to calculate the eigenvector value obtained from combination, so as to obtain a new eigenvector value.

Based on the deep neural network, determining a stable credit score or a stable social credit score of a user may include two stages: the first stage being a training stage, and the second stage a prediction phase. In the training stage, the deep neural network is trained by using a large amount of the input data, a model capable of determining the stable credit score or a stable social credit score of the user may then be obtained. In the prediction stage, the input data of the current user is predicted by using the trained deep neural network. The credit score of the current user is obtained by using the prediction result.

At the training stage, regarding the input data for the five dimensions, i.e., users' credit history, behavioral habits, ability to pay off debts, personal traits, and social networks in the input layer of the deep neural network, a credit marker may be set for the input data. For example, a credit marker 0 is set to indicate that the current input data has good credit; or a credit marker 1 is set to indicate that the current input data has poor credit. Therefore, after processing in the input layer, the hidden layer, and the module layer, after the new eigenvector value is obtained by using the activation function in the module layer of the deep neural network, a corresponding credit marker 0 or 1 of the eigenvector value can be obtained.

When credit markers are set for a large amount of input data and the above processing in the input layer, the hidden layer, and the module layer are performed, a corresponding credit marker 0 or 1 for a large amount of eigenvector values can be obtained. Among the large amount of eigenvector values, one eigenvector value may appear many times, and the eigenvector value may correspond to the credit marker 0 and may also correspond to the credit marker 1. Therefore, a good credit probability value (for example, the probability value being 0 for the credit) and a poor credit probability value (for example, the probability value being 1 for the credit) for each eigenvector value can be obtained; and then the good credit probability value and the poor credit probability value are outputted to the output layer.

After obtaining the corresponding credit marker 0 or the credit marker 1 for a large amount of eigenvector values, a classifier (for example, a Support Vector Machine (SVM) classifier) may be used to determine a good and poor credit probability value that corresponds to each eigenvector value. Details in this regard are not provided herein.

At the training stage, a good credit probability value and a poor credit probability value that correspond to each eigenvector value are recorded in the output layer of the deep neural network. For example, for a certain eigenvector value, when the recorded good credit probability values are 90%, it indicates that the probability for the current eigenvector value to have good credit is 90%; and when the recorded poor credit probability values are 10%, it indicates that the probability for the current eigenvector value to have poor credit is 10%.

At the prediction phase, no credit marker is currently set for the input data of the five dimensions, i.e., users' credit history, behavioral habits, ability to pay off debts, personal traits, and social networks in the input layer of the deep neural network, because what needs to be determined at the end is whether the input data is data with good credit or data with poor credit. Therefore, after processing in the input layer, the hidden layer, and the module layer is performed and after a new eigenvector value is obtained by using the activation function in the module layer of the deep neural network, the new eigenvector value is directly outputted to the output layer.

The corresponding relationships between a large amount of eigenvector values and the good credit probability values and poor credit probability values are recorded in the output layer of the deep neural network. As a result, after an eigenvector value from the module layer is obtained, an eigenvector value matching the currently obtained eigenvector value may be found in the locally recorded eigenvector values, so as to obtain a good credit probability value and a poor credit probability value corresponding to the eigenvector value.

Based on the currently obtained good credit probability value and the poor credit probability values, the input data is graded so as to get the stable credit score or stable social credit score of the current user. For example, for input data from a user 1, after processing in the deep neural network is performed, the obtained good credit probability value is 90%, and the obtained poor credit probability value is 10%. For input data from a user 2, after processing in the deep neural network is performed, the good credit probability value is 95%, and the poor credit probability value is 5%. Therefore, the credit score or a social credit score for the user 1 is 450 and the credit score or a social credit score for the user 2 is 600.

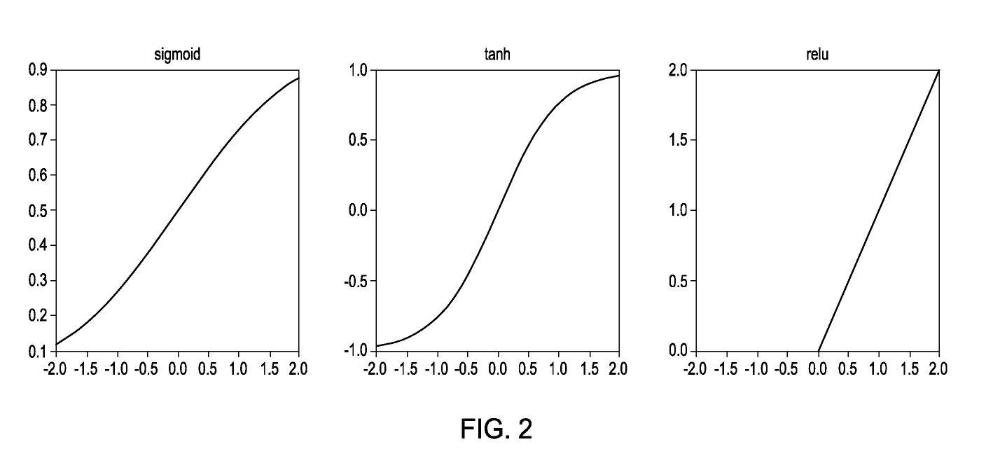

In the above process, both the activation function used by the hidden layer and by the module layer can be a sigmoid function, a ReLU function, and a tan h function. The graphs of the sigmoid function, the ReLU function, and the tan h function are shown like those in FIG. 2. Moreover, a calculation formula of the sigmoid function may be sigmoid x=1/1+ê−x; a calculation formula of the ReLU function may be ReLU [symbol] ; and a calculation formula of the tan h function may be tan h x=ex−e−x/ex+e−x.

Referring to FIG. 2, in the process of implementing the present invention, the applicant noticed that for the sigmoid function, when the input varies between −2.0 and 2.0, the output varies between 0.1 and 0.9; that is, the output is always greater than 0. For the ReLU function, when the input varies between 0 and 2.0, the output varies between 0 and 2.0; that is, the output is always greater than or equal to 0. For the tan h function, when the input varies between −2.0 and 2.0, the output varies between −1.0 and 1.0; that is, the output may be a positive value or a negative value.

In a common deep neural network, the sigmoid function, the ReLU function, and the tan h function can be used. However, in the deep neural network that needs obtain a credit score or a social credit score, since processing data in five dimensions is involved, the data processing results for some dimensions in actual inventions may include negative values, which better shows the data characteristics for the dimension. As such, the sigmoid function and the ReLU function are clearly not applicable, because they cannot provide data processing results with negative values. Therefore, for the deep neural network that obtains the stable credit score or a stable social credit score, the tan h function may be used as the activation function.

Further, when the tan h function is used as the activation function, the input range is generally between 0 and 1 after processes such as normalization is performed. Referring to FIG. 2, for the tan h function, when the input is near 0, the output is approximately linear and has a large slope. Thus, when the input changes, the corresponding output also varies greatly. For example, when the input changes from 0 to 0.1, the output also changes from 0 to 0.1. When the input changes from 0 to 0.2, the output also changes from 0 to 0.2. Therefore, when the tan h function is used as an activation function, the stability of the output cannot be guaranteed when a change occurs in the input.

In actual applications, when there is a great change in the user's data over time, such as consumer data may have greater changes on different dates (such as a sudden change on a certain day), it can be ensured that the user's credit or social credit is a in a stable state; that is, the credit or social credit score only has a small change. Therefore, in a deep neural network that needs to obtain a credit score or social credit score and in the case of using the tan h function as an activation function, when the data changes greatly, there is no guarantee that the credit score or social credit score will only have a small change. Evidently, the tan h function is no longer applicable. A new activation function needs to be designed to ensure that the output has only a small change when the input changes, thereby ensuring the stability of the output. For example, when the input changes from 0 to 0.1, the output changes from 0 to 0.01. When the input changes from 0 to 0.2, the output changes from 0 to 0.018.

For the deep neural network that obtains the stable credit or social credit, in the above process, the input may refer to the eigenvector value inputted to the activation function; and the output may refer to the eigenvector value outputted by the activation function.

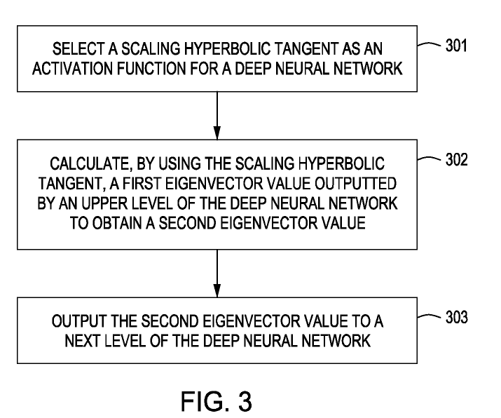

For the above problems, a new activation function is designed in this embodiment of the present invention and the activation function is called a scaling hyperbolic tangent. The scaling hyperbolic tangent is described in detail below. When the scaling hyperbolic tangent is used in the deep neural network, it is guaranteed that there is only a small change in the output when the input changes, thereby ensuring the stability of the output. Based on the scaling hyperbolic tangent, an embodiment of the present invention provides a method for outputting an eigenvector value. The method may be applied to a deep neural network. As shown in FIG. 3, the method for outputting the eigenvector value may include the following steps:

Step 301: Select a scaling hyperbolic tangent as an activation function for the deep neural network.

Step 302: Calculate, by using the scaling hyperbolic tangent, a first eigenvector value outputted by an upper level of the deep neural network to obtain a second eigenvector value.

Step 303: Output the second eigenvector value to a next level of the deep neural network.

In the deep neural network, in order to add nonlinear factors, reduce the noise of the actual data, suppress the data with large edge singularities, and constrain the eigenvector values outputted by the upper level, the activation function (such as a nonlinear function) is often used to calculate the first eigenvector value outputted by the upper level of the deep neural network so as to obtain a new second eigenvector value; and the second eigenvector value is outputted to a next level of the deep neural network. The upper level of the deep neural network may refer to either a hidden layer or a module layer that outputs the first eigenvector value to the activation function; after obtaining the first eigenvector value, the hidden layer or the module layer outputs the first eigenvector value to the activation function, so as to calculate the first eigenvector value by using the activation function, thereby obtaining a second eigenvector value. The next level of the deep neural network may refer to either a hidden layer or a module layer to which the second eigenvector value processed by the activation function is outputted; after the first eigenvector value is calculated by using the activation function, a second eigenvector is obtained; and the second eigenvector value is outputted to the hidden layer or the module layer.

As such, in this embodiment of the present invention, a scaling hyperbolic tangent (scaled tan h) can be selected as an activation function of a deep neural network, instead of selecting an sigmoid function, a ReLU function, a tan h function as the activation function for the deep neural network. Further, the selecting a scaling hyperbolic tangent as an activation function for the deep neural network includes, but is not limited to the following method: determining a hyperbolic tangent and reducing the slope of the hyperbolic tangent, so as to obtain the scaling hyperbolic tangent; and selecting the scaling hyperbolic tangent as the activation function for the deep neural network.

The scaling hyperbolic tangent includes, but is not limited to: scaled tan h(x)=β*tan h(α*x); as such, in a process of using the scaling hyperbolic tangent to calculate the first eigenvector value outputted by the upper level so as to obtain the second eigenvector value, x is the first eigenvector value, scaled tan h(x) is the second eigenvector value, tan h(x) is the hyperbolic tangent, β and α are preset values, and α is less than 1 and greater than 0.

The calculation formula of the hyperbolic tangent tan h(x) can be tan h x=ex−e−x/ex+e−x. It can be seen by referring to FIG. 2, the result of tan h(x) is between (−1.0 to −1.0), therefore, the result of tan h(α*x) is also between (−1.0 to −1.0). In this way, the range of the output value can be controlled with a preset value β; that is, the range of the output value is (−4, 0). In a possible implementation, β may be chosen to be equal to 1, so that the range of the output value is from (−1.0 to −1.0); that is, the output value range of the hyperbolic tangent remains unchanged.

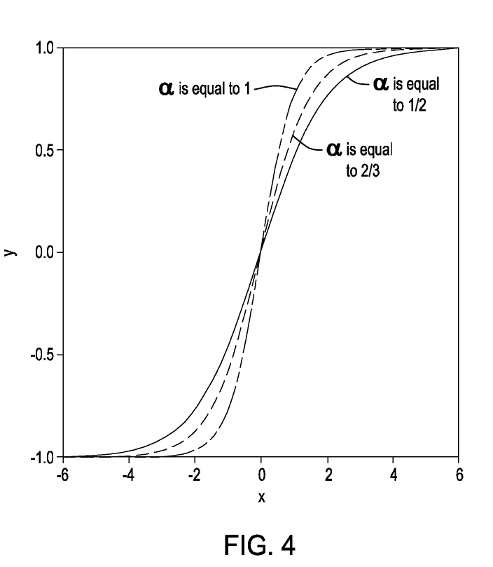

FIG. 4 is a schematic diagram of the scaling hyperbolic tangent. It can be seen from FIG. 4 that the slope of the hyperbolic tangent is controlled by using α. When α is less than 1, the slope of the hyperbolic tangent can be reduced. Moreover, as α becomes smaller, the slope of the hyperbolic tangent also becomes smaller, so the sensitivity of the scaling hyperbolic tangent to the input is also reduced; the goal of enhancing output stability is then achieved.

When α becomes smaller, the result of (α*x) also becomes smaller. According to the characteristics of the hyperbolic tangent, the result of tan h(α*x) also becomes smaller. Therefore, the result of the scaling hyperbolic tangent scaled tan h (x) will become smaller. In this way, when the input range is between 0 and 1 and the input is near 0, the output of the scaling hyperbolic tangent is not approximately linear; and the slope is small. For the input that changes, the corresponding output has a small change. For example, when the input changes from 0 to 0.1, the output may simply change from 0 to 0.01. When the input changes from 0 to 0.2, the output may simply change from 0 to 0.018. Therefore, when the scaling hyperbolic tangent is used as the activation function, the stability of the output can be ensured when a change occurs in the input.

In the above process, the input may be the first eigenvector value inputted to the scaling hyperbolic tangent; and the output may be the second eigenvector value outputted by the scaling hyperbolic tangent.

The scaling hyperbolic tangent used in the above process of the embodiments of the present invention can be applied to the training stage of the deep neural network, and can also be applied to the prediction stage of the deep neural network.

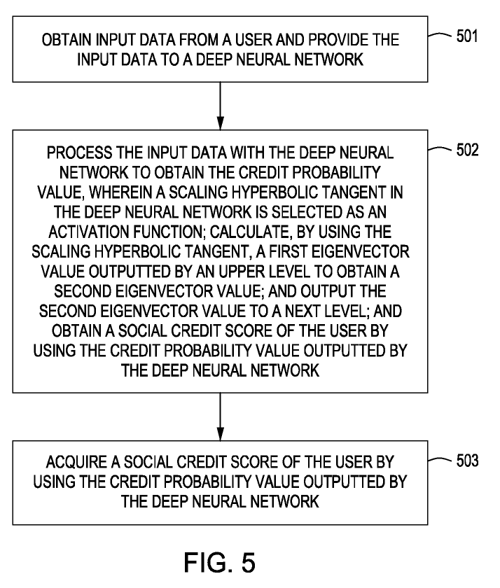

The scaling hyperbolic tangent designed in this embodiment of the present invention can be applied to any deep neural network known in the prior art. That is, the deep neural network in all scenarios can use the scaling hyperbolic tangent as the activation function. In a possible implementation, the scaling hyperbolic tangent can be applied to a personal credit reference model; that is, the scaling hyperbolic tangent is used as an activation function in a deep neural network that obtains credit scores. As such, this embodiment of the present invention provides a method for obtaining a stable credit score or social credit score. In the method, the scaling hyperbolic tangent may be used in the deep neural network as the activation function; then it is guaranteed that there is only a small change in the output when the input changes, thereby ensuring the stability of the output. As shown in FIG. 5, the method for obtaining a stable credit score or social credit score provided in this embodiment of the present invention may include the following steps.

Step 501: Obtain input data from a user and provide the input data to a deep neural network.

Step 502: Process the input data with the deep neural network to obtain the credit probability value, wherein a scaling hyperbolic tangent in the deep neural network is selected as an activation function; calculate, by using the scaling hyperbolic tangent, a first eigenvector value outputted by an upper level to obtain a second eigenvector value; and output the second eigenvector value to a next level.

Step 503: Acquire a credit score or social credit score of the user by using the credit probability value outputted by the deep neural network.

In this embodiment of the present invention, the input data may be data for the five dimensions, i.e., users' credit history, behavioral habits, ability to pay off debts, personal traits, and social networks. In addition, the credit probability value may be good credit probability values and/or poor credit probability values. Based on the currently obtained good credit probability value and the poor credit probability values, the input data is graded so as to get the credit score or a social credit score of the current user. For the detailed process of obtaining the credit score or social credit score, reference can be made to the above process, which is not repeated herein.

In the deep neural network, in order to add nonlinear factors, reduce the noise of the actual data, suppress the data with large edge singularities, and constrain the eigenvector values outputted by the upper level, the activation function (such as a nonlinear function) is often used to calculate the first eigenvector value outputted by the upper level of the deep neural network so as to obtain a new second eigenvector value; and the second eigenvector value is outputted to a next level of the deep neural network. The upper level of the deep neural network may refer to either a hidden layer or a module layer that outputs the first eigenvector value to the activation function; after obtaining the first eigenvector value, the hidden layer or the module layer outputs the first eigenvector value to the activation function, so as to calculate the first eigenvector value by using the activation function, thereby obtaining a second eigenvector value. The next level of the deep neural network may refer to either a hidden layer or a module layer to which the second eigenvector value processed by the activation function is outputted; after the first eigenvector value is calculated by using the activation function, a second eigenvector is obtained; and the second eigenvector value is outputted to the hidden layer or the module layer.

When the activation function is used in the hidden layer, the first eigenvector value outputted by the upper level may include: an eigenvector value for a data dimension outputted by the hidden layer in the deep neural network, such as the eigenvector value for the users' credit history dimension or the eigenvector value for the personal trait dimension.

When the activation function is used in the module layer, the first eigenvector value outputted by the upper level may include: eigenvector values for multiple data dimensions outputted by the module layer in the deep neural network; for example, an eigenvector value for the users' credit history dimension; an eigenvector value for the behavioral habits dimension; an eigenvector value for the ability to pay off debts dimension; an eigenvector value for the personal trait dimension; or an eigenvector value for the social networks dimension.

As such, in this embodiment of the present invention, a scaling hyperbolic tangent (scaled tan h) can be selected as an activation function of a deep neural network, instead of selecting an sigmoid function, a ReLU function, a tan h function as the activation function for the deep neural network. Further, the selecting a scaling hyperbolic tangent as an activation function for the deep neural network includes, but is not limited to the following method: determining a hyperbolic tangent and reducing the slope of the hyperbolic tangent, so as to obtain the scaling hyperbolic tangent; and selecting the scaling hyperbolic tangent as the activation function for the deep neural network.

The scaling hyperbolic tangent includes, but is not limited to: scaled tan h(x)=β*tan h(α*x); as such, in a process of using the scaling hyperbolic tangent to calculate the first eigenvector value outputted by the upper level so as to obtain the second eigenvector value, x is the first eigenvector value, scaled tan h(x) is the second eigenvector value, tan h(x) is the hyperbolic tangent, β and α are preset values, and α is less than 1 and greater than 0.

The calculation formula of the hyperbolic tangent tan h(x) can be tan h x=ex−e−x/ex+e−x. It can be seen by referring to FIG. 2, the result of tan h(x) is between (−1.0 to −1.0), therefore, the result of tan h(α*x) is also between (−1.0 to −1.0). In this way, the range of the output value can be controlled with a preset value β; that is, the range of the output value is (−β, β). In a possible implementation, β may be chosen to be equal to 1, so that the range of the output value is from (−1.0 to −1.0); that is, the output value range of the hyperbolic tangent remains unchanged.

FIG. 4 is a schematic diagram of the scaling hyperbolic tangent. It can be seen from FIG. 4 that the slope of the hyperbolic tangent is controlled by using α. When α is less than 1, the slope of the hyperbolic tangent can be reduced. Moreover, as a becomes smaller, the slope of the hyperbolic tangent also becomes smaller, so the sensitivity of the scaling hyperbolic tangent to the input is also reduced; the goal of enhancing output stability is then achieved.

When α becomes smaller, the result of (α*x) also becomes smaller. According to the characteristics of the hyperbolic tangent, the result of tan h(α*x) also becomes smaller. Therefore, the result of the scaling hyperbolic tangent scaled tan h (x) will become smaller. In this way, when the input range is between 0 and 1 and the input is near 0, the output of the scaling hyperbolic tangent is not approximately linear, and the slope is small. For the input that changes, the corresponding output has a small change. For example, when the input changes from 0 to 0.1, the output may simply change from 0 to 0.01. When the input changes from 0 to 0.2, the output may simply change from 0 to 0.018. Therefore, when the scaling hyperbolic tangent is used as the activation function, the stability of the output can be ensured when a change occurs in the input.

In the above process, the input may be the first eigenvector value inputted to the scaling hyperbolic tangent; and the output may be the second eigenvector value outputted by the scaling hyperbolic tangent.

The scaling hyperbolic tangent used in the above process of the embodiments of the present invention can be applied to the training stage of the deep neural network, and can also be applied to the prediction stage of the deep neural network.

Based on the above technical solutions, in embodiments of the present invention, the scaling hyperbolic tangent is used as the activation function so as to enhance the stability of the deep neural network. When the deep neural network is applied to a personal credit reference system, it can enhance the stability of the credit score or social credit score, avoiding great changes in the credit score or social credit score, and thereby improving use experience. For example, when there is a great change in the user's data over time, such as consumer data may have greater changes on different dates (such as a sudden change on a certain day), it can be ensured that the user's credit is in a stable state; that is, the credit score or social credit score only has a small change, and the stability of the credit score or social credit score is ensured.

The above method for outputting the eigenvector value and the method for obtaining the credit score or social credit score can be applied to any device in the prior art, as long as the device can use the deep neural network for data processing. For example, the methods can be applied to an ODPS (Open Data Processing Service platform.

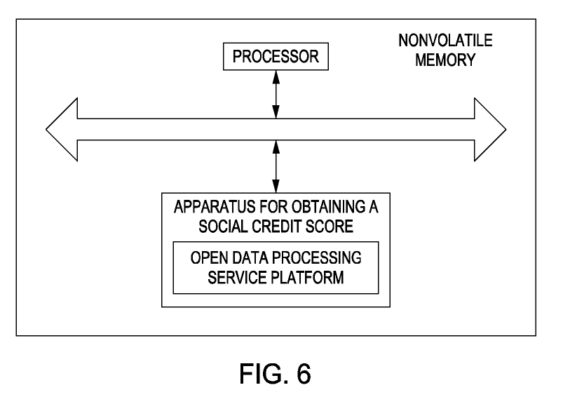

Based on the same invention idea as the one in the above method, this embodiment of the present invention further provides an apparatus for obtaining a credit score or social credit score, which is applied to an open data processing service platform. The apparatus for obtaining a credit score or social credit score can be implemented through software, hardware, or a combination of hardware and software. When software implementation is used as an example, as a logic device, it is formed by the processor reading corresponding computer program commands in a nonvolatile memory, wherein the processor is provided on the open data processing service platform where the apparatus locates. At the level of hardware, as shown in FIG. 6, it is a hardware structure chart of an open data processing service platform where an apparatus for obtaining a credit score or social credit score disclosed in the present invention locates. Other than the processor and nonvolatile as shown in FIG. 6, the open data processing service platform may further be configured with other types of hardware, such as a transfer chip for processing messages, a network interface and a memory. At the level of hardware structure, this open data processing service platform may also be a distributed device, which may include a plurality of interface cards for implementing the extension of message processing at the level of hardware.

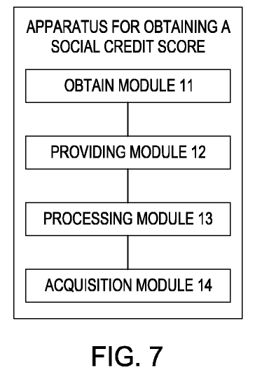

As shown in FIG. 7, a structure chart of the apparatus for obtaining a credit score or social credit score disclosed in the present invention is illustrated; and the apparatus comprises:

an obtaining module 11, configured to obtain input data from a user;

a providing module 12, configured to provide the input data to a deep neural network;

a processing module 13, configured to process the input data with the deep neural network to obtain the credit probability value, wherein a scaling hyperbolic tangent in the deep neural network is selected as an activation function; calculate, by using the scaling hyperbolic tangent, a first eigenvector value outputted by an upper level to obtain a second eigenvector value; and output the second eigenvector value to a next level; and

an acquisition module 14, configured to acquire a credit score or social credit score of the user by using the credit probability value outputted by the deep neural network.

The processing module 13 is configured to determine, in the process of selecting the scaling hyperbolic tangent as the activation function, a hyperbolic tangent and reduce the slope of the hyperbolic tangent, so as to obtain the scaling hyperbolic tangent; and select the scaling hyperbolic tangent as the activation function for the deep neural network.

In this embodiment of the present invention, the scaling hyperbolic tangent selected by the processing module 13 comprises: scaled tan h(x)=β*tan h(α*x); in the process of the processing module using the scaling hyperbolic tangent to calculate the first eigenvector value outputted by the upper level so as to obtain the second eigenvector value, x is the first eigenvector value, scaled tan h(x) is the second eigenvector value, tan h(x) is the hyperbolic tangent, β and a are preset values, and α is less than 1 and greater than 0.

In this embodiment of the present invention, the first eigenvector value outputted by the upper level comprises: an eigenvector value of a data dimension outputted by a hidden layer of the deep neural network; and eigenvector values of a plurality of data dimensions outputted by a module layer of the deep neural network.

In the process, various modules of the device disclosed in the present invention can also be configured separately. The above modules may be combined into one module, or further divided into multiple sub-modules.

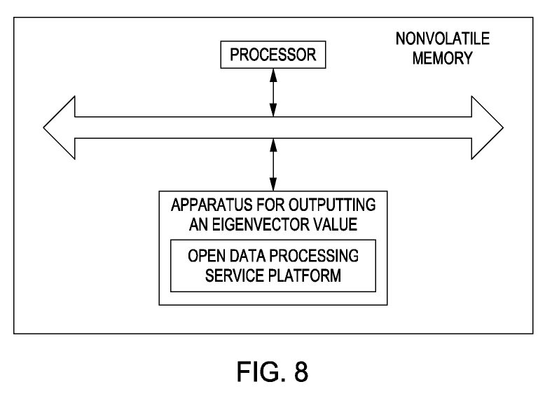

Based on the same invention idea as the one in the above method, this embodiment of the present invention further provides an apparatus for outputting an eigenvector value, which is applied to an open data processing service platform. The apparatus for outputting an eigenvector value can be implemented through software, hardware, or a combination of hardware and software. When software implementation is used as an example, as a logic device, it is formed by the processor reading corresponding computer program commands in a nonvolatile memory, wherein the processor is provided on the open data processing service platform where the apparatus locates. At the level of hardware, as shown in FIG. 8, it is a hardware structure chart of an open data processing service platform where an apparatus for outputting an eigenvector value disclosed in the present invention locates. Other than the processor and nonvolatile as shown in FIG. 8, the open data processing service platform may further be configured with other types of hardware, such as a transfer chip for processing messages, a network interface and a memory. At the level of hardware structure, this open data processing service platform may also be a distributed device, which may include a plurality of interface cards for implementing the extension of message processing at the level of hardware.

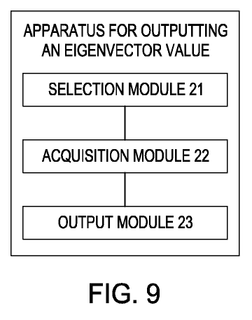

FIG. 9 is a schematic diagram of an apparatus for outputting an eigenvector value according to the present invention, wherein the apparatus for outputting an eigenvector value is applied to a deep neural network, and the apparatus for outputting an eigenvector value comprises:

a selection module 21, configured to select a scaling hyperbolic tangent as an activation function of the deep neural network; an obtaining module 22, configured to calculate, by using the scaling hyperbolic tangent, a first eigenvector value outputted by an upper level of the deep neural network to obtain a second eigenvector value; and

an output module 23, configured to output the second eigenvector value to a next level of the deep neural network.

In this embodiment of the present invention, the selection module 21 is configured to determine, in the process of selecting the scaling hyperbolic tangent as the activation function for the deep neutral network, a hyperbolic tangent and reduce the slope of the hyperbolic tangent, so as to obtain the scaling hyperbolic tangent; and select the scaling hyperbolic tangent as the activation function for the deep neural network.

In this embodiment of the present invention, the scaling hyperbolic tangent selected by the selection module 21 comprises: scaled tan h(x)=β*tan h(α*x); in the process of the processing module using the scaling hyperbolic tangent to calculate the first eigenvector value outputted by the upper level so as to obtain the second eigenvector value, x is the first eigenvector value, scaled tan h(x) is the second eigenvector value, tan h(x) is the hyperbolic tangent, β and α are preset values, and α is less than 1 and greater than 0.

In the process, various modules of the device disclosed in the present invention can be configured separately. The above modules may be combined into one module, or further divided into multiple sub-modules.

In the preceding description of embodiments, those skilled in the art will can clearly understand that the present invention may be implemented by software plus a necessary general hardware platform, and also be implemented by hardware. Based on such understanding, the essence of the technical solutions of the present invention or the part that makes contributions to the prior art may be embodied in the form of a software product. The computer software product is stored in a storage medium and includes several instructions for instructing a computer device (which may be a personal computer, a server, a network apparatus, or the like) to perform the methods described in the embodiments of the present invention. Those skilled in the art will understand that the accompanying drawings are schematic diagrams of a embodiments, and modules or processes in the accompanying drawings are not necessarily mandatory for implementing the present invention.

Those skilled in the art will understand that modules in the apparatus in embodiments can be distributed in the apparatus according to description of embodiments, and may also be correspondingly changed to be positioned in one or more apparatuses different from that in the present embodiment. The modules of foregoing embodiments may be combined into one module, or further divided into multiple sub-modules. The aforementioned sequence numbers of embodiments of the present invention are merely for the convenience of description, and do not imply the preference among embodiments.

Disclosed herein are several embodiments of the present invention. However, the present invention is not limited thereto, and any equivalents and obvious variations that can be conceived of by those skilled in the art shall fall within the protection scope of the present claims.

What is claimed is:

1. A method for obtaining a stable credit score for use in credit management, comprising:
configuring an obtaining module to obtain input data from a user and providing the input data to a deep neural network;
configuring a processing module to process the input data through the deep neural network to obtain a credit probability value;
configuring an obtaining module to obtain a credit score of the user by using the credit probability value outputted by the deep neural network; and
selecting a scaling hyperbolic tangent in the deep neural network as an activation function; calculating, by using the scaling hyperbolic tangent, a first eigenvector value outputted by an upper level to obtain a second eigenvector value; and outputting the second eigenvector value to a next level, to obtain the stable credit score.

2. The method according to claim 1, wherein the process of selecting a scaling hyperbolic tangent in the deep neural network as an activation function comprises:
determining a hyperbolic tangent and reducing a slope of the hyperbolic tangent, so as to obtain the scaling hyperbolic tangent; and selecting the scaling hyperbolic tangent as the activation function for the deep neural network.

3. The method according to claim 1, wherein
the scaling hyperbolic tangent comprises: scaled tan h(x)=β*tan h(α*x); and
when the scaling hyperbolic tangent is used to calculate the first eigenvector value outputted by the upper level so as to obtain the second eigenvector value, x is the first eigenvector value, scaled tan h(x) is the second eigenvector value, tan h(x) is the hyperbolic tangent, β and α are preset values, and α is less than 1 and greater than 0.

4. The method according to claim 1, wherein the first eigenvector value outputted by the upper level comprises: an eigenvector value of a data dimension outputted by a hidden layer of the deep neural network; and eigenvector values of a plurality of data dimensions outputted by a module layer of the deep neural network.

5. A method for outputting an eigenvector value for obtaining a stable credit score for use in credit management, comprising:
configuring a selection module to select a scaling hyperbolic tangent as an activation function for a deep neural network;
configuring an obtaining module to calculate, by using the scaling hyperbolic tangent, a first eigenvector value outputted by an upper level of the deep neural network to obtain a second eigenvector value, and
configuring an output module to output the second eigenvector value to a next level of the deep neural network, for obtaining the stable credit score.

6. The method according to claim 5, wherein the process of configuring a selection module to select a scaling hyperbolic tangent as an activation function for the deep neural network comprises:
determining a hyperbolic tangent and reducing a slope of the hyperbolic tangent, so as to obtain the scaling hyperbolic tangent; and selecting the scaling hyperbolic tangent as the activation function for the deep neural network.

7. The method according to claim 5, wherein
the scaling hyperbolic tangent comprises: scaled tan h(x)=β*tan h(α*x);
when the scaling hyperbolic tangent is used to calculate the first eigenvector value outputted by the upper level so as to obtain the second eigenvector value, x is the first eigenvector value, scaled tan h(x) is the second eigenvector value, tan h(x) is the hyperbolic tangent, β and α are preset values, and α is less than 1 and greater than 0.

8. An apparatus for obtaining a stable credit score for use in credit management, comprising:
an obtaining module, configured to obtain input data from a user;
a providing module, configured to provide the input data to a deep neural network;
a processing module, configured to process the input data with the deep neural network to obtain the credit probability value, wherein a scaling hyperbolic tangent in the deep neural network is selected as an activation function; calculate, by using the scaling hyperbolic tangent, a first eigenvector value outputted by an upper level to obtain a second eigenvector value; and output the second eigenvector value to a next level; and
an acquisition module, configured to acquire a credit score of the user by using the credit probability value outputted by the deep neural network.

9. The apparatus according to claim 8, wherein
the processing module is configured to determine, in the process of selecting the scaling hyperbolic tangent as the activation function, a hyperbolic tangent and reduce the slope of the hyperbolic tangent, so as to obtain the scaling hyperbolic tangent; and select the scaling hyperbolic tangent as the activation function for the deep neural network.

10. The apparatus according to claim 8, wherein
the scaling hyperbolic tangent selected by the processing module comprises: scaled tan h(x)=β *tan h(α*x); in the process of the processing module using the scaling hyperbolic tangent to calculate the first eigenvector value outputted by the upper level so as to obtain the second eigenvector value, x is the first eigenvector value, scaled tan h(x) is the second eigenvector value, tan h(x) is the hyperbolic tangent, β and α are preset values, and α is less than 1 and greater than 0.

11. The apparatus according to claim 8, wherein the first eigenvector value outputted by the upper level comprises: an eigenvector value of a data dimension outputted by a hidden layer of the deep neural network; and eigenvector values of a plurality of data dimensions outputted by a module layer of the deep neural network.

12. An apparatus for outputting an eigenvector value for obtaining a stable credit score for credit management, comprising:
a selection module, configured to select a scaling hyperbolic tangent as an activation function of the deep neural network;
an obtaining module, configured to calculate, by using the scaling hyperbolic tangent, a first eigenvector value outputted by an upper level of the deep neural network to obtain a second eigenvector value; and
an output module, configured to output the second eigenvector value to a next level of the deep neural network, for obtaining the stable credit score.

13. The apparatus according to claim 12, wherein
the selection module is configured to determine, in the process of selecting the scaling hyperbolic tangent as the activation function for the deep neutral network, a hyperbolic tangent and reduce the slope of the hyperbolic tangent, so as to obtain the scaling hyperbolic tangent; and select the scaling hyperbolic tangent as the activation function for the deep neural network.

14. The apparatus according to claim 12, wherein
the scaling hyperbolic tangent selected by the selection module comprises: scaled tan h(x)=β*tan h(α*x); in the process of the obtaining module using the scaling hyperbolic tangent to calculate the first eigenvector value outputted by the upper level so as to obtain the second eigenvector value, x is the first eigenvector value, scaled tan h(x) is the second eigenvector value, tan h(x) is the hyperbolic tangent, β and α are preset values, and α is less than 1 and greater than 0.
